(19) United States
(12) Patent Application Publication
(10) Pub. No.: US 2005/0067341 A1
(43) Pub. Date: Mar. 31, 2005

(54) Continuous production membrane water treatment plant and method for operating same

(76) Inventors: Dennis H. Green, Arvada, CO (US); George D. Piegols, Highlands Ranch, CO (US); John A. Lombardi, Boulder, CO (US); Gary Joseph Herbert, Westminster, CO (US)

Correspondence Address: SHERIDAN ROSS PC, 1560 BROADWAY, SUITE 1200, DENVER, CO, 80202, US

(21) Appl. No.: 10/946,276

(22) Filed: Sep. 20, 2004

Related U.S. Application Data
(60) Provisional application No. 60/505,480, filed on Sep. 25, 2003.

(51) Int. Cl. B01D 65/02

(52) U.S. Cl. 210/321.69; 210/321.6

(57) ABSTRACT

A method is provided for the continuous production of treated waters using a staged, tapered array membrane plant by a process of process-logic-controlled (PLC) stage or stage increment isolation and removal from service, washing and return-to-service concurrent with the continued operation of all other stages and/or stage increments of the plant. Specifically, there are plant mounted input/output sensors that supply the PLC with the data required to identify the location and degree of “fouling” of the individual stages or stage increments of a tapered array membrane water treatment plant, where fouling is defined as a loss of water flow through a membrane surface at a given pressure when compared to a water flow standard for the surface. When a stage or stage increment of a plant is defined by this process to be “fouled,” the PLC commands the initiation of a sequence of automated valve openings and closings to a) remove the fouled stage or stage increment from feed water treatment service, b) to flush and wash the stage or stage increment, and c) to return the stage or stage increment to feed water treatment service. Optionally the PLC function can be extended to include the monitoring and control of ancillary valves and a variable-frequency-drive feed water pump to command the parts of a plant that remain on-line during the process of a stage or stage increment wash to continue to produce more, or less, or volumetrically identical amounts of membrane water treatment process permeate by combinations of valve re-settings, pump speed adjustments, and stage-to-stage intermediate water diversion.

### CROSS REFERENCE TO RELATED APPLICATION

The present application claims the benefits of U.S. Provisional Application Ser. No. 60/505,480, filed Sep. 25, 2003, entitled “Membrane Plant On-Line Tail-End Wash Method”, which is incorporated herein by this reference.

### FIELD OF THE INVENTION

The present invention relates generally to effluent treatment and specifically to removing emulsions and solids from membranes.

### BACKGROUND OF THE INVENTION

With water shortages and environmental protection gaining global importance, membrane treatment of contaminated waters is becoming more widespread. Membranes can separate effectively suspended solids, entrained oils and greases, dissolved solids, and dissolved organics, and produce a low contaminant-content permeate water. Membranes can also conserve reagent-loaded matrix waters for recycle and recover valuable metals from metal-loaded waters.

Membranes push feed water across leaves of membrane material with a permeate pocket on the underside of the leaf. The leaves are spiral wound around a hollow central tube. The permeate pockets communicate with the interior of the central tube. Typical commercial membrane packages, called membrane elements, are 2½″, 4″ or 8″ diameter and 39″ long. The elements are connected in series element-by-element by permeate tube inter-connectors in, typically, six element lengths. The connected elements are confined in a pipe with end-caps called a membrane vessel or unit. A unit may contain one or more membrane elements. Feed water is pumped into the vessel at one end and exits out the other, less the volume of permeate that was collected to the central tube for recovery. The liquid on the rejection side of the membrane is called the concentrate or retentate, and the fluid that passes through the membrane is called the permeate.

Membranes can have a high “fouling” potential when used to treat waters carrying organics and dissolved solids (such as salts, hydroxides, polymers, guar, and colloids). The concentration(s) of the contaminant(s) in such waters typically range(s) from about 500 to about 130,000 ppm. These contaminants can, upon concentration, exceed solubility limits and precipitate and/or form emulsions that occlude the membrane surface and inhibit efficient permeate production. As permeate water is extracted from a feed water, the concentrate water that lies atop a membrane becomes increasingly contaminated with the dissolved contaminants that are membrane rejected. By extracting permeate water, the contaminant content of the concentrate water becomes layered atop the membrane such that the degree of contaminant content is greatest at the membrane surface in what is called the “boundary layer,” i.e., the contaminants tend to “stack-up” at the membrane rejection interface. The boundary layer is a zone where there is a high potential: a) for the formation and precipitation of solids due to the presence of dissolved solids in excess of their solubility limits and b) for the formation of solid-organic emulsions due to the physical proximity and crowding of contaminant materials. The formation of precipitate solids and/or solid-organic emulsions creates a potential for membrane-occlusion-by-adhesion of particulates and/or emulsions. Membrane occlusion reduces the rate of passage of permeate water at a given pressure and is referred to as “membrane surface fouling.” To reduce the potential for membrane fouling, state-of-the-art industrial membrane water treatment plants are designed as flow-through units, i.e., as units where a cross-flow of pressurized concentrate water passes over the membrane at all times to purposefully sweep the membrane surface and disrupt the formation of the boundary layer.

FIG. 5 depicts a typical membrane tapered array membrane plant 500 according to the prior art. The plant includes first, second, and third stage filtration arrays 504, 508, and 512. Each array commonly includes a collection of six-element vessel bundles of the same or differing diameters, with the membrane vessels in the various arrays being the same type (and pore size) of membrane and removing the same type of contaminants. Membrane types include ultrafilters, nanofilters, microfilters, and hyperfilters. The tapered array descriptor for the plant comes from the need to size the number and/or diameter of the vessels and/or number of elements housed in a vessel in each stage of the plant in a manner consistent with reduced flow that enters the downstream stages of the plant relative to the feed to the plant, the pressure and specific permeate production rates in the plant, and the need to adhere to the minimum cross-flow guidelines for each membrane vessel type. With reference to FIG. 5, the first stage filtration array 504 receives the feed stream F₁ and produces a retentate F₂ and permeate P₁; the second stage filtration array 508 receives the retentate F₂ and produces a retentate F₃ and permeate P₂; and the third stage filtration array 512 receives the retentate F₃ and produces a retentate F₄ and permeate F₃. The relative flow rates/volumes of the retentates are F₂>F₃>F₄ and of the permeates are P₁>P₂>P₃. Typically, the array is designed to halve the vessel array volume in stages for each 50% removal of stage specific feed water as permeate. For example, a 50% recovery first-stage vessel array 504 feeds a half-size second-stage vessel array 508, that, in turn, extract 50% of its feed water and feeds a half-size third-stage vessel array 512, and so forth in accordance with the ultimate recovery goal of the process. In accordance with the need to maintain a concentrate water cross-flow velocity high enough to disrupt the formation of the boundary layer, commercial six-element membrane vessels are designed with the following, typical, minimum concentrate cross-flow stipulations: a) 12-16 gpm for an 8″ vessel; b) 3-4 gpm for a 4″ vessel; and c). 1.2-1.6 gpm for a 2½″ vessel.

FIG. 6 depicts a typical array in a stage, such as the third stage filtration array 512. The array includes first, second, . . . . Nth membrane vessels 600a-n connected to a common manifold 604. The input feed stream F₃ is introduced into the manifold 604 which delivers simultaneously or in parallel a fractional share of the feed stream to each of the vessels 600a-n, i.e., 1/N F₃ to each of the vessels. The input feed stream is introduced into the manifold at a rate sufficient to pressurize each vessel and effect permeate production in a context of concentrate water cross-flow fouling control. Each vessel in each stage of the system produces a stream of permeate water 608a, b, . . . n that exits the system. As shown in FIG. 6, the permeate streams are typically made common by collection via a common manifold. The pressure on the hydraulically-connected-concentrate water side of the system stages is the same from the front-end to the tail-end of the system, less the line losses accruing to the passage of the concentrate water through the vessels and stage inter-connecting manifolds.

The rate of permeate production in any vessel in any stage of a membrane water treatment system is commonly a direct function of the driving pressure on the concentrate side of the membrane, where driving pressure is a combination of water quality, membrane permeability, and water temperature effects, relative to the type of membrane or selected rejection characteristics, e.g., “tightness,” of the membrane. For example, using the treatment of a 1000 ppm total-dissolved-solids (TDS) water with no suspended solids or organic content as a baseline or “standard” for comparison, the water that would enter the third stage of a three stage process would be 4,000 ppm TDS if 75% of the feed water was extracted precedent to the third stage and if there was a perfect, 100%, rejection of dissolved solids by the membrane. The “specific rate” of permeate production from the third-stage vessels, i.e., the volume of permeate produced on a per-square-foot or per-square-meter basis at a given pressure, would be less than that of the first stage because of the higher TDS value. The loss of “specific” rate of permeation for a high dissolved solids content solution relative to a low dissolved solids content solution is due to a reduced “driving pressure,” i.e., to a reduction in the difference between the given pressure and the osmotic pressure of the water, where osmotic pressure directly increases as a function of the dissolved solids concentration of a water. In the above described system the “specific” rate of permeate production of the third-stage vessels would in fact also be reduced by the fact of reduced pressure in the third stage relative to the first stage due to the line and manifold pressure losses accruing to the passage of the pressurized concentrate water through the system.

Periodically, membranes require washing to remove emulsions and solids partially or fully occluding the membrane surface and impairing membrane performance. Increased plant feed pressure for a given permeate production is the typical indicator of the need for a plant wash to remove emulsions and/or solids from the membrane surface. When the indicator indicates that a plant wash is necessary, the entire plant is commonly shutdown until the wash sequence is completed. Plant washing is typically effected using a multiplicity of wash reagents, including: a) high-pH surfactants for the lifting of loosely adhering solids from the membrane surface and occasional dissolution of scale; b) low-pH, acid “dissolution reagents” for the dissolution of chemical scale; c) chelating agents for the removal of precipitated metals that are not acid soluble; and d) the use of non-specific chemical reagents to dissolve acid and base dissolution refractory amalgams and other exotic occlusion agents. Whole plant washing is a time consuming and reagent consumptive process where all membranes are commonly exposed to all wash reagent types regardless of the degree or type of fouling that may or may not exist on any given membrane surface in the system. This multiple reagent wash process can reduce the life of the membranes, where the life of membrane is defined by a loss of per-cent rejection efficiency of contaminants from the membrane surface.

Due to the drastic loss of permeate production from plant shutdown during membrane washing, redundant stages have been considered to permit the plant to continue operation. FIG. 5 shows a redundant filtration array 516 used as a backup to the third stage filtration array 512. When the third stage filtration array 512 is washed, the feed F₃ is redirected to the redundant filtration array 516 as feed F₃′, which produces retentate F₄′ and permeate P₃′. The redundant array 516 is typically a mirror image of the third stage filtration array 512; therefore, the flow rates and volumes of the permeates P₃ and P₃′ are identical. Redundant arrays can also be used for the remaining stages of the plant depending on the application. Although this configuration can maintain permeate production unchanged during the washing of the third stage filtration array 512, the cost of installing a redundant array is substantial. Moreover, the redundant array typically only maintains production while one array is washed. The remaining arrays require an additional respective redundant array, further increasing costs.

### SUMMARY OF THE INVENTION

These and other needs are addressed by the various embodiments and configurations of the present invention. The present invention is directed to a membrane treatment method and system that flushes and/or washes a stage and/or stage increments of a staged, tapered array membrane treatment plant in which permeate continues to be produced on a continuous basis for all parts of the plant that are not being actively washed.

In a first embodiment of the present invention, a membrane plant for treating a feed stream is provided. The plant treats a feed stream including one or more dissolved and/or entrained target materials. The plant includes first and second membrane stages. The first membrane stage precedes the second membrane stage. Each membrane stage treats a respective portion of the feed stream, includes one or more membrane units, and produces both a concentrate including preferably most (or more than half) (if not all) of the target material and a permeate including a portion of liquid in the feed stream. The plant performs the following steps:
(a) determining that one or more membrane units in one of the first and second membrane stages has at least a selected degree of fouling from a fouling material collected on the membrane surface of the membrane unit;
(b) directing a respective portion of the feed stream around the fouled membrane unit;
(c) flushing and/or washing the fouled membrane unit, while the portion of the feed stream is bypassing the unit, to remove at least a portion of the fouling material; and
(d) when the membrane unit is unfouled, redirecting the respective portion of the feed stream to the unfouled membrane unit for treatment. In the embodiment, most (if not all) of the redirected feed stream portion is not passed through a membrane unit configured in parallel with the fouled membrane unit. Alternatively or additionally, most (if not all) of the redirected feed stream portion is treated by one or more other membrane unit(s) in the affected stage. Normally when the membrane unit is operational, the membrane unit(s) treating the bypassed feed stream is/are also operational (except when undergoing a flush/wash cycle).

In one plant configuration, preferably some and more preferably most (if not all) of the redirected feed stream portion is not treated by a downstream membrane unit. This is the case, for example, where the fouled membrane unit(s) are located in the last downstream membrane stage, such as the third stage. In this configuration, at least most of the redirected feed stream portion is discharged in the concentrate output by the membrane plant.

In another plant configuration, preferably some and more preferably most (if not all) of the redirected feed stream portion is treated by one or more downstream membrane unit(s) and some may be redirected to the plant concentrate discharge. This is the case, for example, where the fouled membrane unit(s) are located in an upstream membrane stage, such as the first or second stage.

In either configuration, each of the membrane units in the affected stage can be bypassed so that all of the membrane units in the affected stage are offline for flushing and/or washing at the same time. Alternatively, the membrane unit(s) treating the redirected feed stream portion are configured in parallel with the bypassed membrane unit(s). For example, the membrane unit(s) treating the redirected feed stream and the fouled membrane unit(s) are connected to a common input manifold.

In either configuration, permeate is produced on a continuous basis for all stages and/or stage increments of the plant that are not being actively washed. The produced permeate can be volumetrically identical to the stage outputs that existed prior to the execution of the wash. Alternatively, the produced permeate can be volumetrically less (typically no more than about 20% less) than the pre-existing stage outputs. Which permeate production level is maintained is generally determined by the maximum desired rate of fouling of the membrane unit(s) remaining in operation.

Other adjustments can be made to the plant to accommodate the pressure and production losses from taking one or more membrane unit(s) offline. For example, a variable pressure valve can be reset to provide additional back pressure to replicate most (if not all) of the back pressure contribution from the offline membrane unit(s) when operational. In another configuration specific to the flushing and/or washing of the end or final downstream stage, the pressure valve is adjusted so as to maintain the volumetrically identical permeate flows from the forward stages of the plant. This adjustment can mimic the back-pressure of the stage that's removed from service to thereby create an unchanged pressure context upstream of the offline membrane unit(s) and thereby create the specified flows.

In another configuration, the permeate waters produced on a continuous basis for all stages or stage increments of the plant that are not being actively washed are cumulatively volumetrically identical or substantially identical to the whole plant output that existed prior to the execution of the wash. The sought-for permeate flow volume addition, being identical to the volume of permeate flow lost to the execution of the stage or stage increment isolation-wash process, can be effected by one or more of a) an increase in feed water flow to the plant to effect an increase in plant line and manifold pressure to, in turn, increase the production of permeate from all non-wash involved elements of the plant or b) the use of mimic back pressure to control the permeate flow from the forward stages and parallel stage increments of the plant with routing of sufficient volumes of by-pass water through the downstream stages of the plant to increase plant line and manifold pressures to, in turn, increase the production of permeate from the downstream stages. This creates the specified flows coincident with the dumping of water from the feed stream to the downstream stages of the plant if the by-pass volume is over-large relative to the prescribed permeate/concentrate need.

In yet another configuration, staged, tapered array plant stages are parsed into sufficiently small increments to enable the wash shut-down of any portion (typically a single) stage increment such that the plant continues to operate, without any adjustments to the feed water or the plant back pressure, at a permeate production rate nominally equal to the permeate production rate of the plant before the wash procedure execution. This plant configuration thereby creates a continuous production, nearly constant permeate volume production plant, that, by a method of serial or sequential washing of stage increments, does not require the diversion of feed water due to a wash related cause. A tail-end throttle valve may be required to boost the permeate production of the plant during the interval of a stage or stage increment wash.

In yet another configuration and depending on a wide variety of factors, including but not limited to, the number of stages in the plant, the size of the stage or stage increments selected for monolithic wash removal from service, the operating pressure of the plant, the hydraulic design of the plant, the location of the stage or stage increment removed from service in the plant, and the volume of by-pass water accruing to the stage or stage increment removal, the plant includes a) adjustment of feed to the plant by re-sets of the plant feed variable-frequency-drive (VFD) pump to either increase or decrease the flow-rate of water to the plant during a stage or stage increment wash and b) the dumping of all or part of the by-pass water from a stage or stage increment wash event. These controls may be necessary to off-set the effects of the stage or stage increment removal from service effects, including, but not limited to; a) the line and feed and discharge manifold pressure losses associated with feed water passage through the stage or stage increment being reduced to zero and b) the membrane surface area of the plant being reduced by the stage or stage increment removal from service. Whereas the effects of a stage or stage increment removal from service are measurable and quantifiable, the redistribution of pressures and water flow effects throughout the plant are normally less predictable. Accordingly, the adjustments to the feed flow to the plant and/or the dumping of stage or stage increment by-pass waters may be required to bring the plant back from deleterious flow related pressure and specific permeate production increase effects that, at the outset, are difficult to predict.

Any of the plant configurations may be implemented using a process-logic-control (PLC) system. The PLC receives measurements from a mix of sensors, such as pressure and temperature sensors and flow meters, to detect a fouling condition in one or more membrane unit(s) and, in response thereto, control the valves necessary to isolate the affected stage or stage increment, redirect the feed stream as needed, and conduct the flushing and washing cycle on the affected stage or stage increment. The PLC system can remove all increments of the various plant stages to be serially, but not necessarily sequentially, removed from service, washed as required, and returned to service. In this manner a full plant wash can be affected without the need for a full plant shut-down or a redundant collection of membrane units. Optionally, the producing, on-line stage or stage increments of the aforesaid described plant can be I/O device monitored, automated valve and variable-frequency-drive (VFD) pump equipped and PLC controlled to produce more or less or the same amount of permeate water as before the stage or stage increment wash process to thereby variously compensate for the permeate loss that accrues to the stage or stage increment removal from service. This can limit the plant loss of permeate to the permeate water production from the removal from service of a stage or stage increment. The pump may be PLC-controlled to relieve the plant of permeate water production volume by feed water turn-down to a point less than that exhibited precedent to the stage or stage increment removal from service. This can lessen the impact of the sometimes large volumes of by-pass water produced accruing to the stage or stage increment removal from service process on the downstream stages or parallel stage increments of the system. The latter case of feed water turn-down is usually effected in response to the removal of a stage from service, not a stage increment, where the diversion of the full feed volume to the stage cannot be accommodated by the following stage and the option of automatic valve “dumping” of water between the stages is precluded for whatever reason.

In all embodiments of the present invention there is a stage or stage increment isolation process and “flushing” and/or “washing” of the membranes in the isolated vessels. The isolated vessels can be washed in a specific manner, for example, front-end vessel isolation and washing for the lifting of suspended solids can be employed when it is known that there is no potential for solubility-related precipitate occlusion, or a low pH acid dissolution wash might be employed on a tail-end vessel where there is a known violation of the solubility limits for a compound and precipitate occlusion is a predicted, wash maintenance planned, event. These forms of selected washing are quicker to effect and less consumptive of reagent than the “three-stage, high-low-neutral pH, whole plant wash” typically employed by the industry. The stage or stage increments of a plant can be automatic valve plumbed to the wash tanks, reagent feeders and wash pump that attend all membrane water treatment plants. Differing reagent-targeted washes can be used based on the location of a stage or stage increment in the system relative to the type of fouling expected for that part of the system. After the targeted wash and resumption of service, the effect of the wash can be compared to its “standard” performance level to determine the need for a re-wash with either the same or a different reagent. Isolation of stage and stage increments and targeted washing the membranes in a plant can expose membrane units to fewer reagents for shorter periods of time with an implied life-of-membrane benefit.

These and other advantages will be apparent from the disclosure of the invention(s) contained herein.

The above-described embodiments and configurations are neither complete nor exhaustive. As will be appreciated, other embodiments of the invention are possible utilizing, alone or in combination, one or more of the features set forth above or described in detail below.

### BRIEF DESCRIPTION OF THE DRAWINGS

FIG. 1 is a schematic of a staged, tapered array membrane water treatment plant according to an embodiment of the present invention;

FIG. 2 is a schematic of a staged array membrane water treatment plant parsed into increments according to a further embodiment of the present invention;

FIG. 3 is a schematic of a stage increment in the embodiment of FIG. 2;

FIG. 4 is a flow schematic of the PLC control logic used according to an embodiment of the present invention;

FIG. 5 is a schematic of a prior art tapered array membrane water treatment plant;

FIG. 6 is a schematic of a prior art filtration array stage of the plant of FIG. 5; and

FIG. 7 is a graph of increment identifier (vertical axis) versus operational time (horizontal axis).

### DETAILED DESCRIPTION

### The Architecture for Monitoring and Controlling Membrane Fouling

The present invention involves a tapered array membrane plant stage-by-stage or stage increment-by-stage increment pressure and permeate flow input/output (I/O) device monitoring system that, together with process-logic-control (PLC) programming, is effective in assigning a degree of fouling value to the stage or stage increment, as measured against a known standard pressure-permeate flow profile for the stage or stage increment. From the assigned degree of fouling of the stage or stage increment, a further process of the invention is the execution of an automated sequence of valve position changes to effect the diversion of feed water from the fouling affected stage of the plant and to pass the diverted water to the following stage of the plant for a stage wash process, or the parallel stage increments in a stage incremental wash process. Furthermore, a series of flush and wash solution valves are PLC re-set in a PLC-logic prescribed sequence and the wash pump is run to effect the washing of the membranes in the affected stage or stage increment. Similarly, the stage or stage increment is returned to service by a release of the wash process and a PLC re-setting of the valves necessary for the affected stage or stage increments return to feed water treatment service.

When a stage or a stage increment is taken off-line for washing, the remaining stages and/or stage increments can be reconfigured automatically to provide desired permeate production levels in the absence of a redundant array. For example, the pressure or speed of a variable feed drive (VFD) feed pump can be adjusted to provide increased or decreased feed rates to the first and/or subsequent membrane arrays. As will be appreciated, the amount of permeate produced by a membrane is a direct function of the driving pressure (or the liquid pressure on the upstream membrane surface less the opposing osmonic pressure), the liquid temperature, the back pressure on the concentrate or retentate and the feed flow rate, and an inverse function of the TDS of the feed stream and the back pressure on the permeate. To maintain a higher rate of permeate production while a part of the plant is offline, the pressure or speed of the VFD feed pump can be increased or a pressure valve on the output conduit for the concentrate or retentate reset to a smaller orifice size to provide a higher back pressure. To maintain a lower rate of permeate production, the opposite is true.

Although higher permeate production rates can cause a higher rate of fouling on the affected membranes, the various embodiments of the present invention generally balance the permeate production against the rate of fouling in a given stage. The rate of fouling is directly related to the driving pressure (or volumetric flow rate of the feed stream into the plant), the contaminant concentration, and the cross-flow velocity. Membrane plant operation at an increased specific permeate production rate is boundary layer formative and increases the boundary layer risk. Preferably, for any given stage or stage increment the permeate production is maintained at a level that is from about 80 to 99% and more preferably from about 85 to 95% of the permeate production rate at which fouling will occur at an unacceptable rate. In other words, the permeate production is maintained below a level at which the rate of fouling has a selected magnitude. Stated yet another way, the resulting permeate flow increase for each of the other stage increments is preferably no more than about 20% of the flow and most preferably no more than about 5% of the flow, when all of the stage increments in the stage are operating. As a result of the balancing, the present invention can take any stage or stage increment offline while upstream and/or downstream and/or other parallel stage increments continue to produce permeate, with the net result that a substantial percentage of permeate production is maintained even though the plant is not fully operational.

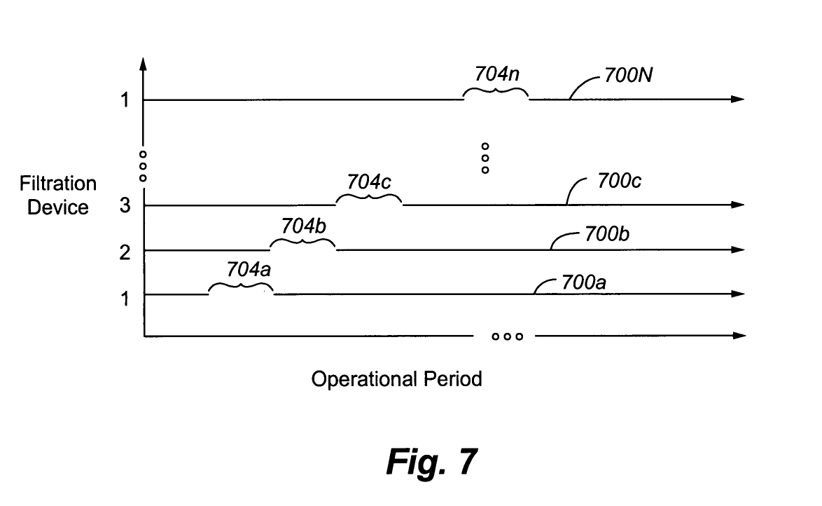

One embodiment of the present invention effects the balancing by parsing the membrane plant into stage-by-stage multi-vessel sub-packages called “stage increments.” Each stage increment is washed during a different, discrete time interval during which the remaining stage increments in the stage remain in operation. This aspect is illustrated in FIG. 7 for a stage comprising N stage increments. The vertical axis shows the stage increment identifier, e.g., stage increment #1, stage increment #2, stage increment #3, . . . stage increment #N. The solid lines 700a-n represent, for each stage increment, the corresponding time periods during which the stage increment is operational while the discontinuities 704a-n in the solid lines 700a-n represent, for each stage increment, the corresponding time interval during the stage increment is offline and being flushed and/or washed. In this manner, the entire stage is not taken offline at the same time for flushing and/or washing. Rather, the stage increments are taken offline at different times while the remaining stage increments in the stage remain operational.

By definition, the stage parsing is designed to limit the amount of stage increment by-pass water to a volume sufficiently small to be treated by the other increments in that stage while maintaining the rate of fouling and the permeate production volume in the other stages to acceptable levels. More specifically, the capacity to remove stage increments from service with impunity relative to the overall effect on the system is dictated by the capacity for those stage increments that operate in parallel with the affected stage increment to accept the by-pass water from the stage increment (that is removed from service) such that there is preferably no significant increase in the stage pressure loss, and no significant increase in the parallel stage increments specific permeate rates. There is no hard-and-fast rule for what constitutes a “significant” line and manifold pressure increase but membrane plants are commonly designed to have a maximum 20% turn-up/turn-down ratio for any stage, and this would normally indicate the need for a minimum six (6 ea.) identical vessels serviced by a common-manifold in each stage of the staged, tapered array plant to effect stage increment wash selections on a one-at-a-time stage increment, removal from service, basis. Each stage can, depending on the application, have multiple manifolds feeding a corresponding array of membrane vessels. Typically, with reference to FIG. 6 the stage increments are selected so that the volumetric proportion of the feed stream F₃ that is handled by each stage increment is no more than about 25% and even more preferably no more than about 15%. As will be appreciated, the input feed stream to each stage increment typically ranges from about 3 to about 60 GFM.

For a membrane water treatment plant that has very low cross-flow through a stage, the addition of more than the above-described 20% turn-up water volume may be acceptable because line losses, exclusive of manifold pressure increase considerations, are a function of the square of the velocity of the fluid traversing the pipe. A “low” cross-flow is typically a cross-flow of no more than about 10 ppm. For a low flow rate, high (e.g., at least about 10,000 ppm TDS) total-dissolved-solids content water treatment system, the 44% increase in friction-related line pressure that accrues to a 20% increase in throughput to accommodate stage increment by-pass water may be only a few pounds-per-square-inch (psi) as measured at the vessel ends, and the few psi change in driving pressure for the high TDS water against a TDS-removal membrane amounts to a negligible increase in permeate production or flux rate and a further turn-up, maybe as high as 33% (4 stage increment per stage) or 50% (3 stage increments per stage), may be tolerable.

Manifold pressure increase considerations must also be addressed when a stage increment is removed from service and the stage increment water is distributed through one less vessel connection orifice. In these cases there can be a dramatic increase in pressure due to a type of “tortuous” effect, i.e., a turbulence induced pressure increase that is similar to the critical velocity “hydraulic jump” in a pipeline. While the line loss may be tolerable at a 33%-50% turn-up flow, the manifold losses may not be acceptable relative to the selection of stage increments for removal from service with impunity. The number of stage increments required in all stages of a plant built to be fully wash capable in a manner that's fully neglectful of the need for automated pressure valve re-settings to produce “dummy” back-pressure or the like, and for the serial selection of stage increments for removal from service with impunity, is set preferably at six (6 ea.) or more identical vessels or common manifold vessel sub-packages except for a rare class of low cross flow, flat pressure-vs-permeate curve, water treatments where stage increments of less than six (6 ea.) or more identical vessels or common manifold vessel sub-packages are determined to be acceptable.

An alternative plant configuration in this embodiment is to include, in the parsed stage, one or more redundant stage increments. The redundant increments are operational when a stage increment is offline but otherwise are not operational. The number of redundant increments is smaller than the number of active stage increments in the corresponding stage and more typically is only one redundant increment for purposes of cost. This plant configuration permits the various parsed increments to have a greater design permeate production capacity than the above-noted configuration as the number of operational parsed increments remains constant during flushing and/or washing.

Another membrane plant embodiment decreases the feed stream flow to all stages and stage increments forward, parallel to, and behind a stage or stage increment being washed. In other words, the pressure or pump speed in the pump providing the feed stream to the first stage filtration array is decreased to provide a desired flow rate. This method of continuous plant operation is not permeate production optimal but it does reduce the potential to create unacceptably high specific permeate production rates from the stages and stage increments parallel to or behind a stage or stage increment in the wash process, a potential that results from the stage or stage increment removal from service by-passing of water to the parallel and following elements of the system, where increased flow increases the line pressure from the front to the back of the effected vessels and the increased line pressure produces an increased specific rate of permeate production and a correspondingly higher rate of fouling. The feed stream flow rate is typically decreased by from about 5 to about 15% and even more typically from about 40 to about 60%.

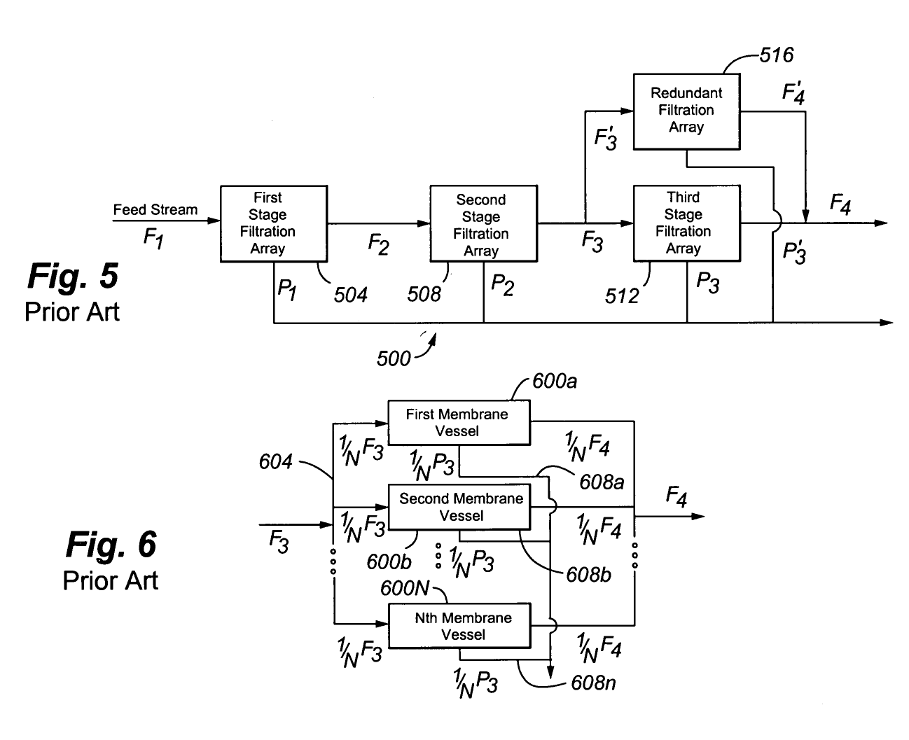

A competing factor that may permit the use of a higher permeate production rate in a parallel stage increment or downstream stage is a lower contaminant (e.g., TDS) concentration in the feed stream to that stage/stage increment. For example, with reference to FIGS. 5 and 6, when the first stage filtration array 504 is taken offline the feed stream F₂ has a lower contaminant concentration due to the absence of upstream membrane concentration. The same is true for the third stage filtration array when the second stage filtration array is taken offline. Assuming that the contaminant concentration is X in the feed stream to the (offline) upstream stage filtration array and assuming a concentration factor in the upstream stage filtration array of Y when the array is in operation, the feed stream flow rate to the selected downstream stage filtration array (the second stage array when the first stage array is offline and the third stage array when the second stage array is offline) is preferably turned up or increased by a maximum of 1/Y (or may receive the feed stream volume normally treated by the upstream array when operational), even more preferably by a maximum of ½Y, and even more preferably by a maximum of ¼Y. In many applications, the increased flow rate will not significantly change the rate of fouling of the selected stage array.

An alternative membrane plant configuration in the above described embodiment where the feed rate is lowered to control the increased risk that accrues to high specific permeate production rates that will occur in the downstream stages or parallel stage increments of a plant that is undergoing a stage or stage increment wash due to the by-pass process is the automated valve dumping of water from the system precedent to the stages where the increased flow accruing to the addition of the by-pass water produces an unacceptably high fouling risk. By way of example, with reference to FIG. 5 if the second stage filtration array 508 is taken offline for washing the flow F₃ may be maintained substantially the same with the difference between F₂ and F₃ being dumped or blended in with the permeate F₄ (provided that the increase in contaminant concentration in F₄ will not exceed permeate requirements/specifications over a selected monitoring period).

Another membrane plant embodiment, executed commensurate with the removal from service and return to service valve re-setting actions that bracket the automated wash process, is to reset (or decrease the orifice size of) one or more other valves to place a “dummy” back-pressure in the system (preferably on the concentrate side) that mimics the line and manifold pressure losses of the affected stage or stage increment when it is on-line. Typically, the orifice size of the valve downstream of the offline stage/stage increment is adjusted to at least substantially compensate for the back pressure contribution of the offline stage/stage increment when operational. More typically, the orifice size is adjusted so as to create a back pressure that is at least about 20% of the back pressure created by the offline stage/stage increment when operational. As will be appreciated, the “dummy” back pressure causes increased permeate production. In this manner, the volumetric flows of the input feed stream, output permeate, and output retentate for each upstream stage, parallel stage increment, and downstream stage remains substantially the same or is otherwise adjusted up or down by no more than a maximum desired amount(s) noted above. The reset valve is typically located on the retentate side of the membrane plant. The dummy back-pressure can create a pressure environment forward of the affected stage that is seamless through the processes of stage or stage increment removal from service, washing and return to service, and coincidentally allows the forward portion of the plant to produce concentrate and permeate water in a seamless, substantially identical volumes, pre-, during- and post-wash, fashion. Typically, the setting (orifice size) of the variable setting pressure valve provides a back pressure that is at least about 10% and more typically at least about 20% of the line and manifold pressure losses of the offline stage/stage increment. For a typical stage, the pressure valve preferably produces a back pressure that is at least about 25 psi and no more than about 100 psi and more preferably ranges from about 25 to about 50 psi. For a typical stage increment, the pressure valve preferably produces a back pressure that is at least about 5 psi and no more than about 20 psi and more preferably ranges from about 5 to about 10 psi.

### Monitoring and Controlling Membrane Fouling on a Stage-by-Stage Basis

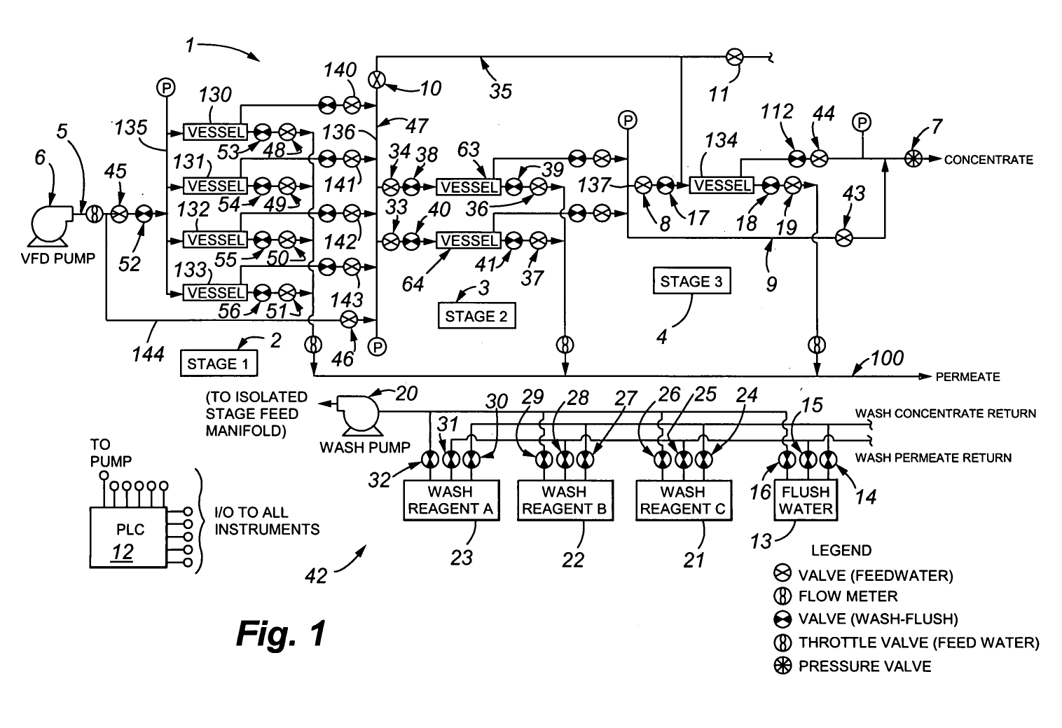

As shown in the embodiment in FIG. 1, any stage of a three stage tapered array membrane plant 1 can be PLC 12 programmed to wash while the remaining stages 2,3,4 remain on-line and in water treatment service. Water from a feed source 5 exits the variable-frequency-drive pump 6 (which may be a centrifugal or differential pressure pump) at a given volumetric rate and a pressure that is principally throttle valve 7 dictated. The other component of the pressure of the plant is the resistance to flow imparted by the passage of feed water 5 through the entirety of the on-line stage components of the vessels 130-133 (stage 1), 63 and 64 (stage 2), and 134 (stage 3) and manifolds 135 (stage 1), 136 (stage 2), and 137 (stage 3).

As shown in FIG. 1, in the specific case of a third stage 4 wash, feed water 5 is diverted by the closing of valve 8 and opening of valve 43 to a by-pass line 9. By the act of initiation of the stage three 4 wash sequence the VFD pump 6 is re-set to reduce the feed water flow to the first stage 2 of the plant as a precaution against over-feeding the plant due to the reduced pressure that accrues to the removal of the third stage 4 from water treatment service. Preferably, the volumetric feed water flow is to less than the selected turn down ratio for the plant and more preferably is at least about 80% of the feed water flow when the plant is fully operational. Optionally (and alternatively to resetting the pump 6) an artificial back-pressure equivalent to the back-pressure that was previously generated by the third stage 4 when it was in-service can be generated by partially closing the throttle valve 7. As will be appreciated, the valve 43 may be replaced by a variable pressure valve and itself set to an orifice size that produces the desired back pressure. By the closing of valves 19 and 44 the third stage can be entirely isolated from the forward first stage and second stage component vessels 130-133 and 63-63.

By a process of PLC 12 control, the (feed water flow 5 isolated) third stage 4 can flushed using recirculation flush water that is pumped by the wash pump 20 and by an opening of the valves 14, 15 and 16. Further, by the process of closing the flush water 13 valves 14, 15, and 16, wash reagent C 21, or wash reagent B 22 or wash reagent A 23, can be circulated through the isolated third stage 4 by the same wash pump 20 and by opening the valves respective to each reagent 21, 22 or 23 on a sequenced basis. Specifically, to effect the washing of a valve-isolated first, second, or third stage, the stage wash valves 17, 18 and 112 are opened and the selected wash reagent valves are opened while the valves of the other wash and flush system valves are closed. To circulate wash reagent C 21 valves 24, 25 and 26 are opened; to circulate wash reagent B 22 valves 27, 28 and 29 are opened; and to circulate wash reagent A 23 valves 30, 31 and 32 are opened. By reversing the wash circuit 42 valve opening sequence, the wash circuit 42 is isolated and the washed stage returned to operation. By way of illustration, this is effected for the third stage 4 by opening the feed water supply valve 8 to the third stage 4, closing the by-pass valve 43, and opening the third stage 4 feed water 5 discharge valves 19 and 43.

Other system parameters changed during the wash sequence are returned to their pre-wash states. When the throttle valve 7 is used to control the back-pressure of the system 1, the throttle valve 7 is reset (or orifice size increased) to its original set position. When the VFD pump 6 was adjusted during the washed stage isolation and flush-wash process, the VFD pump 6 is PLC 12 returned to its pre-wash sequence setting.

As shown in FIG. 1, in the specific case of a second stage 3 wash, the valves 8, 33, 34, 36, and 37 are closed, valve 10 opened, and valve 11 fully or partially closed to thereby divert the feed water 5 component that exits first stage 2 treatment to the by-pass line 35. By the act of initiation of the second stage two 3 wash sequence the VFD pump 6 is preferably re-set to reduce the feed water flow to the first stage 2 of the plant as a precaution against over-feeding the plant due to the reduced pressure that accrues to the removal of the second stage from water treatment service. Optionally an artificial back-pressure equivalent to the back-pressure that was previously generated by the second stage 3, when the second stage was in-service, can be generated by partially closing the throttle valve 7. Alternatively, the valve 10 can be a variable pressure valve that is used to generate the desired back pressure. In one configuration, the valve 11 closure is PLC 12 controlled to allow the retentate of the first stage 1 to enter the third stage 4. Further by the closure of valves 36 and 37 the second stage 3 can be entirely isolated from the feed water 5 flow and by the opening of valves 38, 39, 40 and 41 the second stage 3 can be connected to the wash circuit 42 and the sequence of valve openings and closings can be effected for the flushing 13 and wash reagent washing 21, 22, 23 of the second stage 3. Similar to the process of the reversal of the isolation process described for the third stage 4, by reversing the wash circuit 42 valve opening sequence and returning the second stage 3 to a full feed water 5 and wash circuit 42 isolated condition, the feed water supply valves 33 and 34 to the second stage 3 can be opened, the by-pass valve 10 closed, and the second stage 3 feed water 5 discharge valves 36 and 37 opened to return the second stage 3 to service. When the throttle valve 7 was used to control the back-pressure of the system 1, the throttle valve 7 should be returned to its original set position. When the VFD pump 6 was adjusted during the second stage 3 isolation and flush-wash process, the VFD pump 6 should be PLC 12 returned to its pre-wash sequence setting.

Like the second and third stages, the first stage 2 can be isolated and bypassed when the first stage is flushed and washed with the reagents A, B, and C. This is realized by closing valves 45, 48-51, and 140-143 and opening valve 46 to direct feed stream 5 on the first stage bypass loop 144 to the second stage manifold 47. As noted above, while the first stage 2 is bypassed, the pump 6 can be adjusted to decrease the feed stream 5 volume as a precaution against over-feeding the plant due to the reduced pressure that accrues to the removal of stage one 2 from water treatment service and/or the throttle valve reset to provide back pressure replicating the pressure loss normally caused by the first stage components. The isolation of the first stage 2 can be PLC controlled depending on the application. By the opening of valves 52, 53, 54, 55 and 56 the first stage 2 can be connected to the wash circuit 42 and the sequence of valve openings and closings can be effected for the flushing 13 and wash reagent washing 21, 22, 23 of the first stage 2. Similar to the process of the reversal of the isolation process described for the third stage 4, by reversing the wash circuit 42 valve opening sequence and returning the first stage 2 to a full feed water 5 and wash circuit 42 isolated condition, the feed water supply valve 45 to the first stage 2 can be opened, the by-pass valve 46 closed and the first stage 2 feed water 5 discharge valves 48, 49, 50 and 51 opened to return the first stage 2 to service. The VFD pump 6 and/or throttle valve adjustment(s) made during the first stage 2 isolation and flush-wash process is/are returned to a respective pre-wash sequence setting(s).

### Monitoring and Controlling Membrane Fouling on a Stage Increment-by-Stage Increment Basis

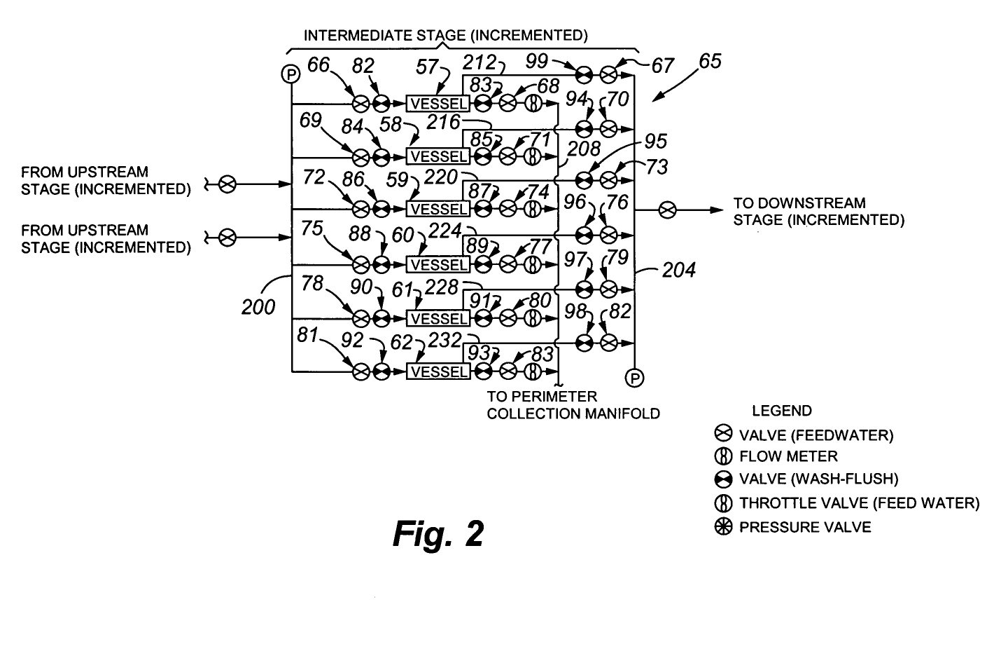

One or more of the first, second, and/or third stages of the membrane plant can be parsed into a plurality of stage increments to provide a plant configuration in which stage increments are isolated, flushed and washed on a stage increment-by-stage increment basis rather than on the stage-by-stage basis of FIG. 1. As shown in FIG. 2 and with reference to FIG. 1, any stage of a multi-stage water treatment plant 1 (such as the first, second, and/or third stages 2, 3, and 4) is shown as being parsed into six or more stage segments 57, 58, 59, 60, 61 and 62 fed simultaneously from a common manifold 200. The retentate outputs, namely 212 for increment 57, 216 for increment 58, 220 for increment 57, 224 for increment 60, 228 for increment 61, and 232 for increment 62, are collected by the manifold 204. The permeate outputs are collected by the manifold 208. In the plant of FIG. 1 with all three stages parsed, six each first stage 8″ increments, second stage 8″ increments one-half loaded with elements, and third stage 8″ increments one-third loaded with elements would replace the vessels shown by FIG. 1 in each stage of the monolithic stage design. Each increment 57, 58, 59, 60, 61 and 62 in the incremented stage design can be as a single vessel or as multiple vessels.

The isolation process for any stage increment 57, 58, 59, 60, 61 and 62 requires the specific closing of valve combinations 66,67 and 68 for stage increment 57, of valve combinations 69,70 and 71 for stage increment 58, of valve combinations 72,73 and 74 for stage increment 59, of valve combinations 75, 76 and 77 for stage increment 60, of valve combinations 78,79 and 80 for stage increment 61, and of valve combinations 81,82 and 83 for stage increment 62. The feed stream to the stage, which is precluded from entering any single stage increment 57, 58, 59, 60, 61 and 62 by the closing of any single valve 66, 69, 72, 75, 78 and 81, respectively, is redistributed throughout the stage feed manifold 200. The redistributed feed stream exits the manifold 200 through the multiplicity of valves 66, 69, 72, 75, 78 and 81 that remain open in deference to the one valve of the same group of increment feed valves 66, 69, 72, 75, 78 and 81 that is closed as part of an increment isolation process.

By the act of initiation of the stage increment 57, 58, 59, 60, 61, and 62 wash sequence the VFD pump 6 is not required to be re-set. The low pressure drop caused by the isolation of one of the stage increments and the increased flow velocity through the remaining on line stage increment vessels and manifolds is commonly not significant enough to warrant other corrective measures, such as pump and/or throttle valve adjustment. In other words, the increased flow velocity and volume through the on line components of the stage is not significant enough to result in an unacceptable rate of fouling in the operating stage increments. The flush and wash system valves opened to flush and wash each of the isolated increments 57, 58, 59, 60, 61 and 62 are: valves 82, 83 and 99 for increment 57; valves 84, 85 and 94 for increment 58; valves 86, 87 and 95 for increment 59; valves 88, 89 and 96 for increment 60; valves 90, 91 and 97 for increment 61; and valves 92, 93 and 98 for increment 61. Opening of the respective set of valves connects the isolated increment 66, 69, 72, 75, 78 and 81 to the flush and wash reagent circuit 42 for membrane flushing and washing. By the system of first, second, and third stage parsing into stage increments, there is typically no need for VFD pump 6 or throttle valve 7 position re-setting for the system to be continuously operative at approximately the same overall permeate production rate, regardless of whether the offline stage increment is in the first, second, or third stage.

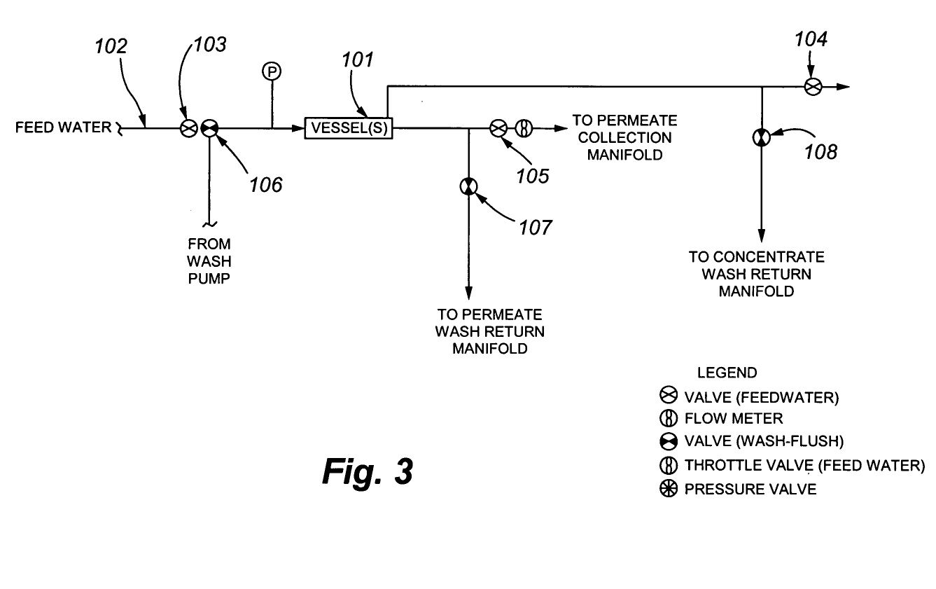

As shown in FIG. 3 with references to FIGS. 1 and 2, any stage increment 57, 58, 59, 60, 61, and 62 in the first, second, or third stage can be comprised of a single vessel 101 or a bundle of vessels connected to a common manifold 102, wherein the flow of feed stream through the manifold to the increment 101 is manifold valve 103 regulated. When the valve 103 is closed, and the retentate valve 104 and permeate valve 105 are closed, the increment 101 is such that connection of the increment 101 to the flush and reagent wash system 42 by the opening of valves 106, 107 and 108 enables the wash system pump 20 to be run to circulate any of the flush water 13 or specific reagents 21, 22 or 23, currently or counter-currently, through the increment 101. All other valves in the selected flush 13 or reagent 21, 22 and 23 circulation sequence being appropriately opened or closed such that a only a flush water 13 or a single reagent water 21, 22 or 23 is passed through the increment 101 at any one time.

### Process-Logic-Control System

The PLC 12 program logic or membrane treatment agent will now be described with reference to FIGS. 1-4. The third stage isolation and flush and reagent wash requires a pressure indicator 109 to be placed in the feed water line 5 precedent to the first stage of the membrane water treatment system 1, a temperature sensor 110 in proximity to the pressure sensor 109, and a flow meter 111 in the common permeate 100 flow from the membrane water treatment plant 1. In one configuration, a pressure sensor (not shown) can be placed in the retentate side (or line) immediately upstream and/or downstream of each of the first, second, and third stages to provide the pressure drop across each stage. In another configuration, a flow meter (not shown) is placed in the retentate side immediately upstream and downstream of each of the first, second, and third stages to provide the flow into and retentate flow out of each stage. In one configuration, a flow meter is placed on the permeate manifold in each of the first, second, and third stages to provide the permeate flow out of each of the stages.

The PLC 12 is attached by feedback lines to the various sensors and meters and control lines to the various automatic isolation valves noted above, the flush and wash system automatic valves noted above, the variable pressure or throttle valve 7, and the VFD pump 6. As discussed below, the PLC 12 is programmed to interpret data inputs from the various sensors and meters and issue appropriate commands to the isolation valves, flush and wash valves, throttle valves, and pump in accordance with the PLC's 12 programmed data interpretation logic 113.

Program logic chip 12 initiates (step 114) the sensor and meter data inquiry and interpretation process by determining if system pressure P1 109 is greater than a pre-determined system pressure set-point (step 115). If P1 is less than or equal to the pre-determined set-point (step 115), the program logic 113 returns to the point of inquiry initiation (step 114) and repeats step 115 again. If the P1 109 pressure is greater than the set-point, the program logic 113 proceeds to step 116.

In step 116, the PLC logic 113 determines if the F1 111 measured flow of the system permeate 100 is less than a system flow set-point 116. If the permeate water flow 100 is greater than or equal to the set-point 116, the logic 113 returns to the inquiry initiation step 114. If the system permeate water 100 flow is less than the set-point 116, the logic 113 proceeds to step 117.

In step 117, the logic 113 determines if the T1 110 measured feed water temperature is greater than a system temperature set-point 117. If the T1 feed water temperature is less than or equal to the set-point, the logic 113 returns to the inquiry initiation step 114. As will be appreciated, colder water has a higher viscosity than warmer water. If the T1 feed water sensor temperature is greater than the set-point, the logic 113 determines that degree of fouling of the third stage requires the third stage to be flushed and washed.

In the steps 118 and 119, the logic 113 initiates the third stage flush and wash sequence. This is done by accessing the stored commands and their issuing sequence. Although a specific set of commands and a command sequence is discussed with reference to steps 120-125, it is to be understood from the previous discussion that the set of commands and command sequence can be different.

In step 120, the logic commands the VFD 6 pump to slow to a third stage wash set-point 120. As will be appreciated, each of the first, second, and third stages will typically have differing set-points for the pump and/or variable pressure valves when the stage is flushed and washed. Normally, the stages are washed at different and discrete (non-overlapping) times due to their substantially different fouling rates. Commonly, the first stage is flushed and washed less frequently than the second stage, and the second stage less frequently than third stage because the contaminant concentrations progressively increase as a result of concentration in the prior (upstream) stage.

After the logic has confirmed that the pump has been appropriately reset (such as by receiving an appropriate reading from the pressure P1 sensor and/or flow meter F1 111 or an acknowledgment from the pump controller), the logic in step 121 commands the opening of the third stage concentrate by-pass valve 43.

After confirming the opening of the concentrate by-pass valve 43 (such as by receiving an acknowledgment command from the valve controller), the logic, in step 122, commands the isolation of the third stage by the closing 122 of automatic valves 8, 19 and 44.

After confirming the closing of each of the valves 8, 19, and 44, the logic, in step 123, commands the execution of the automatic valve openings and closings 17, 18, 112 and 42 and pump 20 circulation of flush and wash reagents solutions 13, 21, 22 and 23 as constitute a third stage wash 123. At the conclusion of the third stage wash, the third stage is valve isolated from the feeding of flush-wash water solutions 13, 21, 22 and 23 and from the feed water supply 5, the flush-wash system valves 42 and third stage wash-flush valves 18 and 112 and feed water valves 19 and 44 are closed, and the feed water by-pass valve 43 is open. The washed third stage of the membrane water treatment system can now be returned to service.

In step 124, the logic returns the third stage to service by opening the feed water 5 valves 44, 19 and 17 simultaneously with the closing of the feed water 5 by-pass valve 43.

After confirming that the commands have been performed, the third stage return to feed water 5 treatment service 124 is then made complete in step 125 by the resetting of the VFD pump 6 to a permeate flow measured F1 set-point.

In step 126, the system 1, fully returned to feed water treatment service, is operated for a selected time period, such as 15 minutes, to allow return to service perturbations to subside before the logic, in step 127, determines whether pressure P1 109 is less than the pressure set-point. If the answer to the P1 inquiry 127 is yes, the logic returns to the initiation step 114. If the answer to the P1 inquiry 127 is no, the logic executes an alarm command in step 128 for operator intervention. Although the system is treating water through each of the first, second, and third stages, the aberrant pressure reading indicates a potential system problem.

As will be appreciated, the logic may be used for flushing and washing of a stage increment in the third stage using the same set points and/or of the first and/or second stage or a stage increment thereof using different set points.

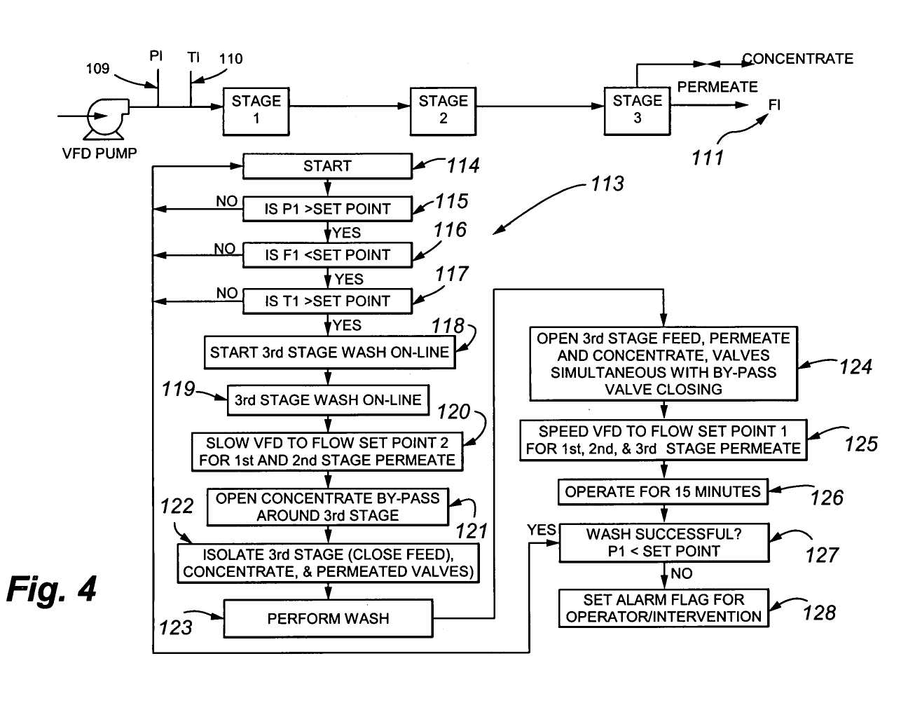

The various set points in FIG. 4 are determined during a “shake-down” process for a new membrane water treatment plant. During shake-down, a stage-by-stage plant pressure and permeate production survey is performed for different feed water flow rates at low and medium percent permeate recoveries at a given feed water temperature. This data serves as a baseline comparator, or “standard,” against which the plant can be compared at all future times, for example after a future wash procedure. In other words, set points are determined based on the data. When permeate production for a the plant as a whole, or for stages or stage increments within a plant, are identified to be comparatively low, determinations can be made as to a degree of fouling and the need for flushing and washing. Note that the permeate-vs-pressure curve comparators for the different stages of a tapered array membrane water treatment plant are created at low permeate recovery rates to decrease the potential for plant performance standard skewing due to precipitate and emulsion formation and occlusion interference.

A number of variations and modifications of the invention can be used. It would be possible to provide for some features of the invention without providing others.

For example in one alternative embodiment, the present invention applies to non-aqueous feed streams, such as industrial solvents and solutions.

In another alternative embodiment, the membrane treatment agent is implemented in software, hardware (as a logic circuit such as an Application Specific Integrated Circuit) or as a combination thereof.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. In a membrane plant for treating a feed stream comprising at least one dissolved and/or entrained target material, the membrane plant comprising at least first and second membrane stages with the first membrane stage preceding the second membrane stage, each membrane stage treating a respective portion of the feed stream, comprising at least one membrane unit, and producing a concentrate comprising at least most of the target material and a permeate comprising a portion of the liquid in the feed stream, a treatment method comprising the steps of:
(a) determining that at least one membrane unit in at least one of the first and second membrane stages has at least a selected degree of fouling from a fouling material collected on a membrane surface of the at least one membrane unit;
(b) directing a respective portion of the feed stream around the at least one membrane unit;
(c) at least one of flushing and washing the bypassed at least one membrane unit during the directing step (b) to remove at least a portion of the fouling material; and
(d) after step (c) is completed, redirecting the respective portion of the feed stream to the at least one membrane unit for treatment, wherein at least one of the following is true:
(i) in the directing step (b), at least most of the redirected respective portion is not passed through a membrane unit configured in parallel with the at least one membrane unit; and
(ii) in the directing step (b), at least most of the redirected respective portion is treated by another at least one membrane unit in the at least one of the first and second membrane stages, wherein, during at least a portion of a time period when the at least one membrane unit is operational, the another at least one membrane unit is operational.

2. The method of claim 1, wherein (i) is true.

3. The method of claim 2, wherein the at least most of the redirected respective portion is not treated by a downstream membrane unit.

4. The method of claim 3, wherein the at least most of the redirected respective portion is discharged as at least a portion of the concentrate output by the membrane plant.

5. The method of claim 2, wherein the at least most of the redirected respective portion is treated by at least one downstream membrane unit.

6. The method of claim 2, wherein each of the membrane units in the at least one of the first and second stages is bypassed in the directing step (b).

7. The method of claim 2, wherein (ii) is true.

8. The method of claim 7, wherein the another at least one membrane unit is configured in parallel with the bypassed at least one membrane unit and wherein the another at least one membrane unit and bypassed at least one membrane unit are connected to a common input manifold.

9. The method of claim 1, further comprising, during at least a portion of the directing step (b), decreasing a volumetric flow of the feed stream through the membrane plant.

10. The method of claim 1, further comprising, during at least a portion of the directing step (b), decreasing an orifice size of a variable pressure valve positioned downstream of the bypassed at least one membrane unit to produce a back pressure, the back pressure offsetting at least a portion of a back pressure produced by the bypassed at least one membrane unit when operational.

11. The method of claim 1, wherein the determining step comprises the substeps of:
determining if at least one of a permeate flow rate and volume is less than a first set point;
determining if an upstream feed stream pressure is greater than a second set point;
determining if a temperature of the feed stream is greater than a third set point;
when the at least one of permeate flow rate and volume is less than the first set point, the upstream pressure is greater than the second set point, and the temperature is greater than the second set point, the at least one membrane unit has at least the selected degree of fouling; and
when the at least one of permeate flow rate and volume is greater than the first set point, the upstream pressure is less than the second set point, and/or the temperature is less than the second set point, the at least one membrane unit does not have at least the selected degree of fouling.

12. An aqueous feed stream treatment method, comprising:
(a) providing a membrane plant for treating an aqueous feed stream comprising at least one dissolved and/or entrained target material, the membrane plant comprising at least first and second membrane stages with the first membrane stage being upstream of the second membrane stage, each membrane stage treating a respective portion of the feed stream, comprising at least one membrane unit, and producing a concentrate comprising at least most of the target material and a permeate comprising a portion of the water in the feed stream,
(b) determining that at least one membrane unit in at least one of the first and second membrane stages has at least a selected degree of fouling from a fouling material collected by the at least one membrane unit;
(c) directing a respective portion of the feed stream around the at least one membrane unit while continuing to operate the other at least one of the first and second membrane stages;
(d) at least one of flushing and washing the bypassed at least one membrane unit during the directing step (c) to remove at least a portion of the fouling material; and
(e) after step (d) is completed, redirecting the respective portion of the feed stream to the at least one membrane unit for treatment, wherein at least one of the following is true:
(i) in the directing step (c), at least most of the redirected respective portion is not passed through a membrane unit configured in parallel with the at least one membrane unit; and
(ii) in the directing step (c), at least most of the redirected respective portion is treated by another at least one membrane unit in the at least one of the first and second membrane stages, wherein, during at least a portion of a time period when the at least one membrane unit is operational, the another at least one membrane unit is operational.

13. The method of claim 12, wherein (i) is true.

14. The method of claim 13, wherein the at least most of the redirected respective portion is not treated by a downstream membrane unit.

15. The method of claim 14, wherein the at least most of the redirected respective portion is discharged as at least a portion of the concentrate output by the membrane plant.

16. The method of claim 13, wherein the at least most of the redirected respective portion is treated by at least one downstream membrane unit.

17. The method of claim 13, wherein each of the membrane units in the at least one of the first and second stages is bypassed in the directing step (c).

18. The method of claim 13, wherein (ii) is true.

19. The method of claim 18, wherein the another at least one membrane unit is configured in parallel with the bypassed at least one membrane unit and wherein the another at least one membrane unit and bypassed at least one membrane unit are connected to a common input manifold.

20. The method of claim 12, further comprising, during at least a portion of the directing step (c), decreasing a volumetric flow of the feed stream through the membrane plant.

21. The method of claim 12, further comprising, during at least a portion of the directing step (c), decreasing an orifice size of a variable pressure valve positioned downstream of the bypassed at least one membrane unit to produce a back pressure, the back pressure offsetting at least a portion of a back pressure produced by the bypassed at least one membrane unit when operational.

22. The method of claim 12, wherein the determining step comprises the substeps of:
determining if at least one of a permeate flow rate and volume is less than a first set point;
determining if an upstream feed stream pressure is greater than a second set point;
determining if a temperature of the feed stream is greater than a third set point;
when the at least one of permeate flow rate and volume is less than the first set point, the upstream pressure is greater than the second set point, and the temperature is greater than the second set point, the at least one membrane unit has at least the selected degree of fouling; and
when the at least one of permeate flow rate and volume is greater than the first set point, the upstream pressure is less than the second set point, and/or the temperature is less than the second set point, the at least one membrane unit does not have at least the selected degree of fouling.

23. An automated membrane treatment system for treating a liquid feed stream comprising at least one dissolved and/or entrained target material, comprising:
(a) at least first and second membrane stages with the first membrane stage being in communication with and preceding the second membrane stage, each membrane stage treating a respective portion of the feed stream, comprising at least one membrane unit, and producing a concentrate comprising at least most of the target material and a permeate comprising a portion of the liquid in the feed stream,
(b) a membrane treatment system operable to remove at least a portion of a fouling material from a membrane unit surface; and
(c) a membrane treatment agent operable to: (1) determine that at least one membrane unit in at least one of the first and second membrane stages has at least a selected degree of fouling from the fouling material collected on a membrane surface of the at least one membrane unit; (2) direct a respective portion of the feed stream around the at least one membrane unit; (3) control the operation of the membrane treatment system to remove at least a portion of the fouling material collected on the membrane surface of the at least one membrane unit; and (4) after operation (3) is completed, redirect the respective portion of the feed stream to the at least one membrane unit for treatment, wherein at least one of the following is true:
(i) in the directing operation (2), at least most of the redirected respective portion is not passed through a membrane unit configured in parallel with the at least one membrane unit; and
(ii) in the directing operation (2), at least most of the redirected respective portion is treated by another at least one membrane unit in the at least one of the first and second membrane stages, wherein, during at least a portion of a time period when the at least one membrane unit is operational, the another at least one membrane unit is operational.

24. The system of claim 23, wherein (i) is true.

25. The system of claim 24, wherein the at least most of the redirected respective portion is not treated by a downstream membrane unit.

26. The system of claim 25, wherein the at least most of the redirected respective portion is discharged as at least a portion of the concentrate output by the membrane treatment system.

27. The system of claim 24, wherein the at least most of the redirected respective portion is treated by at least one downstream membrane unit.

28. The system of claim 24, wherein each of the membrane units in the at least one of the first and second stages is bypassed in the directing operation (2).

29. The system of claim 24, wherein (ii) is true.

30. The system of claim 29, wherein the another at least one membrane unit is configured in parallel with the bypassed at least one membrane unit and wherein the another at least one membrane unit and bypassed at least one membrane unit are connected to a common input manifold.

31. The system of claim 23, wherein the agent is further operable, during at least a portion of the directing operation (2), to decrease a volumetric flow of the feed stream through the membrane treatment system.

32. The system of claim 23, wherein the agent is further operable, during at least a portion of the directing operation (2), to decrease an orifice size of a variable pressure valve positioned downstream of the bypassed at least one membrane unit to produce a back pressure, the back pressure offsetting at least a portion of a back pressure produced by the bypassed at least one membrane unit when operational.

33. The system of claim 23, wherein the determining operation (1) comprises the suboperations of:
determining if at least one of a permeate flow rate and volume is less than a first set point;
determining if an upstream feed stream pressure is greater than a second set point;
determining if a temperature of the feed stream is greater than a third set point;
when the at least one of permeate flow rate and volume is less than the first set point, the upstream pressure is greater than the second set point, and the temperature is greater than the second set point, the at least one membrane unit has at least the selected degree of fouling; and
when the at least one of permeate flow rate and volume is greater than the first set point, the upstream pressure is less than the second set point, and/or the temperature is less than the second set point, the at least one membrane unit does not have at least the selected degree of fouling.
